(19) United States
(12) Patent Application Publication
(10) Pub. No.: US 2008/0078826 A1
(43) Pub. Date: Apr. 3, 2008

(54) Authentication system and method for sports memorabilia

(76) Inventors: Scott David Siebers, Chesterfield, MO (US); Katherine Anne Smith, Eureka, MO (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/522,613

(22) Filed: Sep. 18, 2006

(51) Int. Cl. G06F 17/00

(52) U.S. Cl. 235/375

(57) ABSTRACT

A sports memorabilia object comprises an authentication indicator incorporated into and implanted within the object during the manufacturing process. The indicator is not visible on the exterior of the item, but is adapted to be detected by a detection device to thereby authenticate the item. The authentication indicator may comprise any element or device capable of having a unique identifier associated with the specific object into which the indicator is incorporated and that is detectable by a detection device.

### BACKGROUND OF THE INVENTION

1. Field of the Invention

The present invention is directed to a system and method for authenticating sports memorabilia, and is more particularly directed to the incorporation of an authentication indicator within a sporting goods object during manufacture whereby the authentication indicator can be detected by a detection device to thereby authenticate the object.

2. Description of Related Art

The collection of sports memorabilia has become increasingly popular over the years. Some of the most collectible sports objects are those that have been autographed by a sports personality or other notable individual. It is widely recognized that an original signature on a sports object greatly enhances the collectible value of the item. One of the biggest problems faced by memorabilia dealers and collectors is determining whether the signature on a sports object is genuine. Fraudulent autographs on sports objects are often produced by counterfeiters intending to sell these imitations to unsuspecting customers.

In order to authenticate the genuineness of a specific sports object, it is known to provide a certificate of authenticity with the autographed sports object, wherein the certificate purports to guarantee the authenticity of the autograph and/or item being sold. The certificate of authenticity typically describes the object and includes a notary or other witness verification that the signature appearing on the object is genuine. While a certificate of authenticity is useful for this purpose, it does not fully overcome the problem of counterfeits because the certificate of authenticity itself may be duplicated by counterfeiters selling fraudulently autographed items.

Various processes and systems have been developed in the past in an effort to further avoid fraud and assist in the authentication process. For example, it has been suggested that a unique identifier be physically affixed, applied, or attached to the exterior surface of the sports object and that the same identifier also be provided on the certificate of authenticity to confirm that the object is, in fact, the item to which the certificate of authentication applies. Various identifiers have been suggested for this purpose including a tamper resistant sticker or label having a unique identification number thereon, a hologram incorporating a unique identification number or code, a unique pattern created by a droplet of micro-particles or a fingerprint. In addition, it has also been suggested that information regarding the authenticity of an object may be maintained by a registry. This registry keeps a master list or database of the objects registered with the company and the unique identifiers associated therewith to assist in verifying the authenticity of an object. The registry may also maintain records of ownership of the objects and may make the information accessible via the Internet by collectors and prospective purchasers.

While use of an identifier physically applied or attached to the object, in combination with the use of certificates of authenticity and registry services, are useful in avoiding fraud, the problem remains that a counterfeiter could affix a counterfeit identifier to counterfeit goods, wherein the identifier is merely copied from an authentic item. In addition, the placement of a unique identifier on the exterior surface of the sports object necessarily alters the appearance of the item and can potentially damage the object.

It is therefore an objective of the present invention to provide an authentication system for sports memorabilia that cannot be easily duplicated by counterfeiters. It is yet a further objective to provide a system wherein an autographed sports object can be authenticated without the use of external markings on or attachments to the exterior of the object. It is another objective to provide a system wherein a collector can verify the authenticity of an autographed sports object at a sports show or similar event.

### SUMMARY OF THE INVENTION

The present invention is directed to a sports memorabilia object to be authenticated, a method for producing a sports memorabilia object to be authenticated, and a method and system for authenticating an object of sports memorabilia. The sports memorabilia object may comprise any manufactured sporting goods article used in conjunction with a sporting event including, but not limited to, a baseball, softball, ball bat, ball glove, football, basketball, soccer ball, volleyball, hockey stick, hockey puck, lacrosse stick, lacrosse ball, helmet, or other protective gear. The sports memorabilia object is associated with an authentication event that makes the object unique and collectable as memorabilia, such as the object being signed by a well known sports figure (e.g., a baseball autographed by Ken Griffey, Jr.) or the object being used in a specific sporting event (e.g., a football used in Super Bowl X).

The sports memorabilia object of the present invention includes an authentication indicator incorporated into or implanted within the object during the manufacturing process. The indicator is not visible on the exterior of the item, but is adapted to be detected by a detection device to thereby authenticate the item. Because the indicator is incorporated into the object during the manufacturing process, counterfeiters will find it extremely difficult if not impossible to sell fraudulent items under this system. The authentication indicator may comprise any element or device capable of having a unique identifier associated with the specific object into which the indicator is incorporated or implanted and that is detectable by a detection device. Preferably, the authentication indicator comprises a transponder or other communications device capable of communicating a unique code or identifier to a detection device.

The method for producing a sports memorabilia object in accordance with the present invention comprises the steps of incorporating a unique indicator within a sporting goods object during manufacture of the object such that the indicator is not visible on the exterior of the object, presenting the object for an authenticating event, and associating the unique indicator with authentication information regarding the object. The method for authenticating the sports memorabilia object in accordance with the invention comprises the steps of detecting the unique indicator associated with the object using a detection device, and reviewing the authenticating information associated with the unique indicator to thereby determine if the object is genuine.

In a preferred embodiment, the authentication indicator comprises a radio frequency identification (RFID) tag implanted within the sports object during the manufacturing process. The RFID tag has a unique identification code programmed therein comprising data, letters, numerals, an alphanumeric string, symbols, or any other code that may be uniquely associated with the specific sports object into which the tag has been implanted. The detection device comprises an RF reader adapted to read or obtain the identification code from the RFID tag when placed into contact or close proximity with the object, and to communicate the identification code for purposes of authenticating the item. The identification code may be encrypted, in whole or in part, using encryption technology known in the art to further enhance the security of the system.

In the preferred embodiment, a list of each sports memorabilia object manufactured and of the unique identification code associated therewith is maintained by or on behalf of the object's manufacturer. This list is preferably maintained as a secure computerized database. The list also includes one or more elements of authenticating information associated with the sports object, such as a description of the object, the date on which the object was manufactured, and information regarding the authentication event (e.g., a description of the event, the date of the event, the name of the sports personality who signed the object or “made” the play, the name of one or more witnesses who witnessed the signing or the play, and the like). Additional documents or materials may also be associated with the object such as a photograph of the object, a photograph or video of the authentication event or otherwise related to the object or sports personality signing the object, and other background or historical documents or materials relating to the object, or the person autographing the item and/or making the play. This database may be utilized to authenticate the signature on a specific sports object with reference to the unique identification code. In addition, a user may access the database, preferably via the Internet, to obtain access to the authentication information and the additional documents and materials associated with the object.

In a most preferred embodiment, the detection device is adapted to directly communicate the identification code to a computerized application and database maintained by or on behalf of the sports item manufacturer. For example, the detection device may be an RF reader adapted to receive the unique identification code and electronically transmit the identification code to a computerized application maintained by or on behalf of the manufacturer for purposes of authenticating the object. The computerized application is programmed to receive the identification code and confirm the authenticity of the object to which the identification code is uniquely associated by referencing the computerized database. The computerized application is preferably accessible as an Internet application, and is programmed to also enable a user to access and view the authentication information and additional documents and materials associated with the object. While the identification code may also be made known to the user, for security purposes, it is preferable that at least a portion or all of the identification code is not made known to the user, but maintained only within the database.

The present invention will be better understood from the following detailed description of the invention, read in connection with the drawings as hereinafter described.

### DESCRIPTION OF THE DRAWINGS

FIG. 1 is a perspective view of an autographed baseball in accordance with a preferred embodiment of the present invention.

FIG. 2 is a sectional view taken along line 2-2 of the autographed baseball of FIG. 1, illustrating the placement of an authentication indicator within the core of the baseball.

FIG. 3 illustrates a system for producing and authenticating the signature on the autographed baseball of FIG. 1 in accordance with a preferred embodiment of the invention.

FIG. 4 is a flow chart illustrating the method for producing and authenticating the signature on the autographed baseball of FIG. 1 using the system illustrated in FIG. 3.

### DETAILED DESCRIPTION OF THE INVENTION

The following description is presented to enable any persons skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiment shown, but is to be accorded the widest scope consistent with the principles and features disclosed herein.

The present invention is directed to a sports memorabilia object to be authenticated, a method for producing a sports memorabilia object to be authenticated, and a method and system for authenticating a sports memorabilia object. The sports memorabilia object may comprise any manufactured sporting goods article used in conjunction with a sporting event including, but not limited to, a baseball, softball, ball bat, ball glove, football, basketball, soccer ball, volleyball, hockey stick, hockey pucks, lacrosse stick, lacrosse ball, helmet, or other protective gear. In a preferred embodiment, the sports memorabilia object is a baseball, softball, ball bat, ball glove, football, or basketball, and most preferably is a baseball. The sports memorabilia object is intended to be associated with an authentication event that makes the object unique and collectable as memorabilia, such as being autographed by a sports figure or being used in a specific sporting event. It is anticipated that the manufacturer of the sports memorabilia object may manufacture the object specifically for use in conjunction with an authentication event.

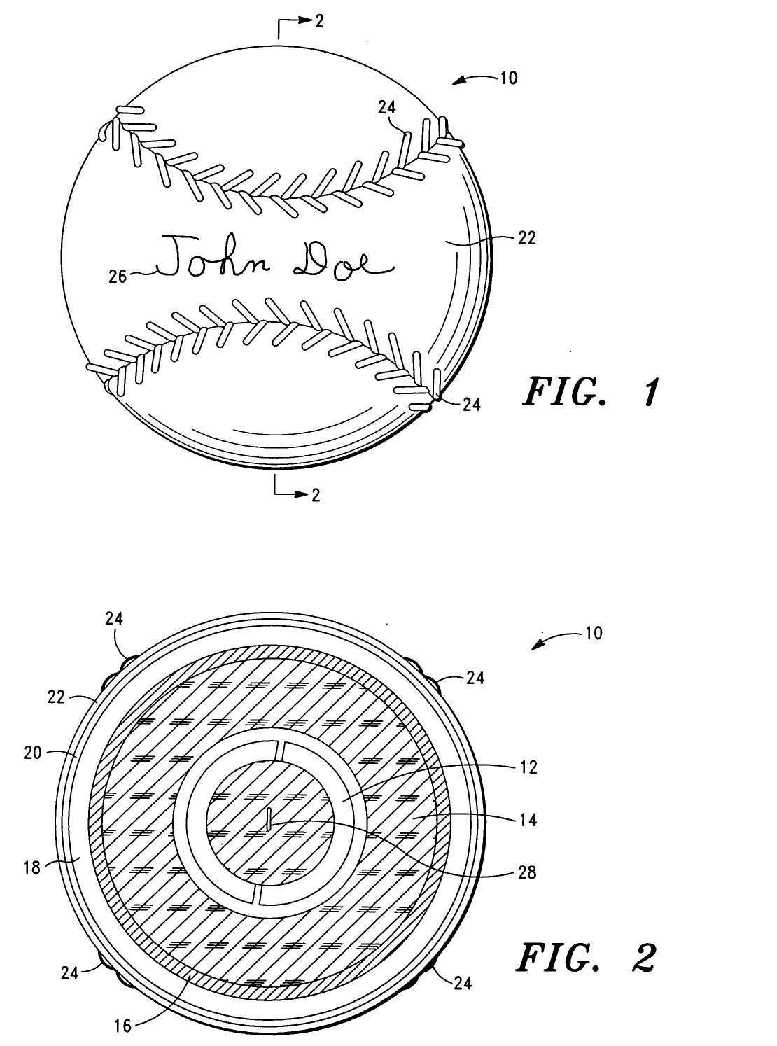

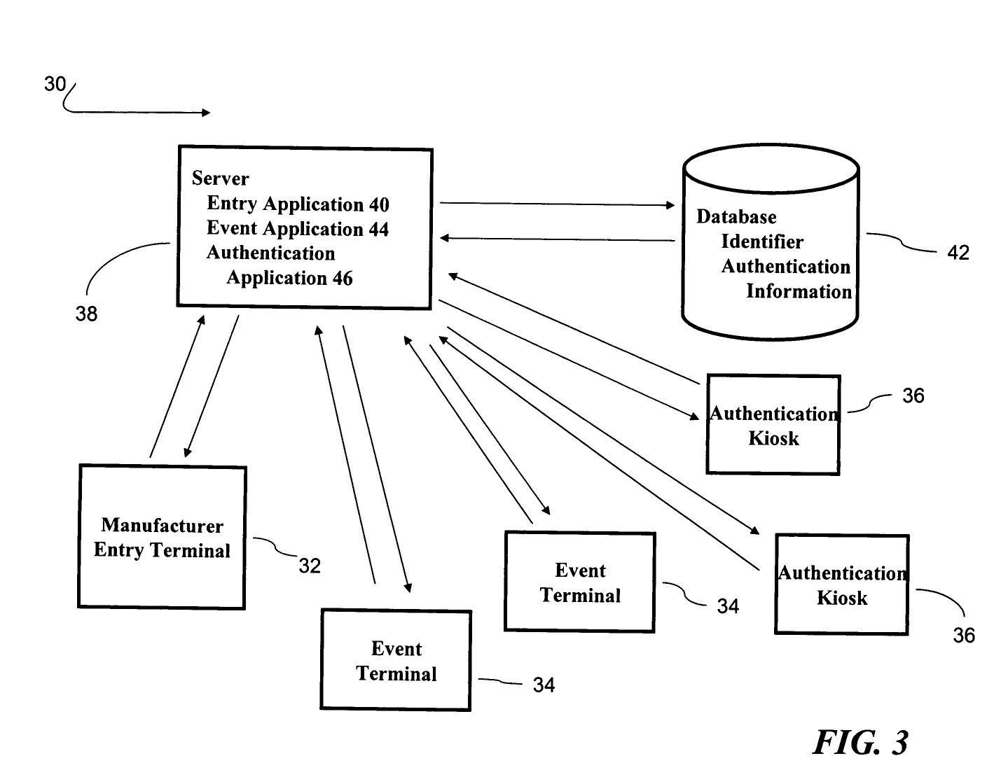

The sports memorabilia object of the present invention includes an authentication indicator incorporated into or implanted within the sports object during the manufacturing process. The indicator has a unique identifier that may be detected by a detection device for purposes of authenticating the object. The indicator is not visible on the exterior of the object, and is incorporated into the item such that removal of the indicator would require disassembly of and possible damage to the sports object. For example, with reference to FIGS. 1 and 2, a baseball made in accordance with a preferred embodiment of the present invention is shown generally as reference numeral 10. Baseball 10 generally comprises a multi-layer core 12, multiple layers of windings 14, 16 and 18, a layer of finish wind 20 and an outer cover 22, all of which are well known in the art. Outer cover 22 is preferably made of leather and typically consists of two 8-shaped members stitched together by conventional threading 24. Located on the exterior surface of outer cover 22 is a signature 26, such as the signature of a famous baseball player.

As shown in FIG. 2, the authentication indicator 28 is implanted within baseball 10 during the manufacturing process. In the illustrated embodiment, indicator 28 is implanted within the central core 12 when the core is being molded. It is to be understood, however, that indicator 28 may be implanted at other locations within baseball 10, such as between finish wind 20 and outer cover 22 or between any two of the layers of winding 14, 16, and 18.

Authentication indicator 28 may be any device or object capable of being incorporated into or implanted within baseball 10 during manufacture without altering the external appearance of the ball, and capable of embodying a unique identifier that can be detected by a detection device when placed in contact or close proximity to baseball 10. If the baseball is intended to be used in play, the incorporation of indicator 28 also cannot impact the playing characteristics of the ball. The authentication indicator 28 should therefore be of a size and configuration sufficient to fit within the object, and must also be capable of withstanding the associated manufacturing conditions such as processing temperatures, pressures and any chemicals and withstand possibly extreme impacts that might be seen in playing conditions. For baseballs, the indicator preferably weighs between 0.01 g and 3 g, most preferably 0.05 g and 1 g. In addition, the indicator is preferably of a size ranging from 5 mm to 20 mm in diameter and 0.5 mm to 3 mm in thickness.

Authentication indicator 28 has a unique identifier encoded or otherwise incorporated therein that may be detected by a detection device. The unique identifier may consist of data, letters, numerals, an alphanumeric string, a combination of symbols, or any other code that can be detected by the detection device and uniquely associated with the baseball. While the unique identifier may be encoded into the indicator after it is implanted within the ball, it is preferable that the unique identifier be programmed or otherwise incorporated into indicator 28 prior to implantation within baseball 10. Most preferably, the unique identifier is incorporated into indicator 28 during manufacture of the indicator, such that indicator 28 is “read-only” in nature and not re-programmable. In this manner, tampering with the unique identifier stored in indicator 28 is essentially impossible. In addition, the unique identifier may be provided in indicator 28 in encrypted form, in whole or in part, as is known in the art to further enhance security of the authentication system.

Authentication indicator 28 may comprise a transponder or other communications device capable of transmitting the unique identifier to the detection device such as a radio frequency identification (RFID) tag. Alternatively, the indicator may comprise a passive identifier that is simply read or otherwise detected by a detection device such as a coded magnetic strip that is capable of being read by a scanner or an identifier that is capable of being read via x-ray, ultrasound or other technologies. In a most preferred embodiment, the authentication indicator is an RFID tag embedded within the sports object during the manufacturing process. The RFID tag is encoded with a unique identification code that is detectable by an RF scanner or reader.

As is known in the art, RFID systems use radio transmissions to send energy to a transponder (the RFID tag), which in turn emits information (e.g., the unique identification code) back to the data collection reader (the RF reader). These systems conventionally utilize two separate antennas—one on the transponder and one of the reader—to accomplish the task of data transfer by radio signals. While any RFID tag capable of being implanted within or incorporated into the sports object is considered suitable for purposes of this invention, the RFID tag is preferably passive in nature meaning that it does not rely upon an internal power source and remains inactive most of the time. The RFID tag transmits the unique identification code in response to an RF signal transmitted by the RF reader. This type of transponder has an indefinite life that makes it ideal for implantation within a sports object. In addition, while the tag may be read only, write only/read many or read/write, it is preferably read only in nature such that the unique identification code is encoded in the tag before it is implanted within the sports object and cannot later be altered. Alternatively, the RFID tag has read/write functionality such that authentication information may be added or written onto the RFID tag at a later time.

RFID tags operate at various frequencies including low frequency operating at about 125 kHz, high frequency operating at about 13.56 MHz, and ultra high frequency operating within the range of 433-915 MHz and 2.45 GHz. For purposes of the present invention, it is preferable that a high frequency tag is utilized such that the reader will pick up a signal being transmitted from within the object when in direct contact or close proximity to the reader. RFID tags considered suitable for purposes of the present invention include Ario Small Module (SM) and Ario Small Disk Module (SDM), commercially available from Tagsys USA, Inc.

The RF reader may be any device capable of “reading” the unique identification code in the RFID tag when placed in contact or close proximity to the sports object into which the tag is implanted. In the preferred embodiment, the RF reader is capable of directly transmitting the identification code to a computerized application and/or database maintained by or on behalf of the manufacturer. In this preferred embodiment, the reader may be connected during use to a PC for sending the data collected from the RFID tag to a host computer through standard interfaces, the data may be stored in a portable hand-held RF reader and uploaded later to a computer for processing, or the tag can be read using an NFC-enabled device such as a mobile phone, PDA or other consumer wireless device capable of transmitting the data via wireless transmission to a computer network. Suitable RF readers include Tagsys L-P101 and Tagsys Medio™ L100 and Tagsys Medio™ L200, commercially available from Tagsys USA, Inc.

A serial number portion of the identification code may be displayed to the user on the RF reader or on the applicable computer screen. This serial number may also be provided on a certificate of authenticity provided to the purchaser of the object. A security code portion of the identification code is preferably not displayed to the user or otherwise made known to the purchaser of the object or any other third parties. Instead, the security code portion is exclusively transmitted to and stored within the database to associate the specific object having that security code encoded therein with the applicable authentication information. The security code portion may be encrypted to further enhance security. Alternatively, the entirety of the identification code may be displayed and/or provided to the user and purchaser of the object.

The sports object may be authenticated by reference to a master list or database comprising the unique identification codes assigned to the various sports objects, such as baseball 10. The database also includes one or more items of authenticating information associated with the object. Examples of such authenticating information include the date on which the object was manufactured, a description of the event or the name of the sports personality who signed the object or made the play, the date on which the event occurred or object was signed, a description of the object, and the name of one or more witnesses who witnessed the event or signing of the object. In the preferred embodiment, this information is maintained in a secure computerized database maintained by or on behalf of the manufacturer of the sports objects. The database may be made accessible via the Internet or other computer network to enable a dealer or prospective purchaser to authenticate the object and to possibly check the registry of owners.

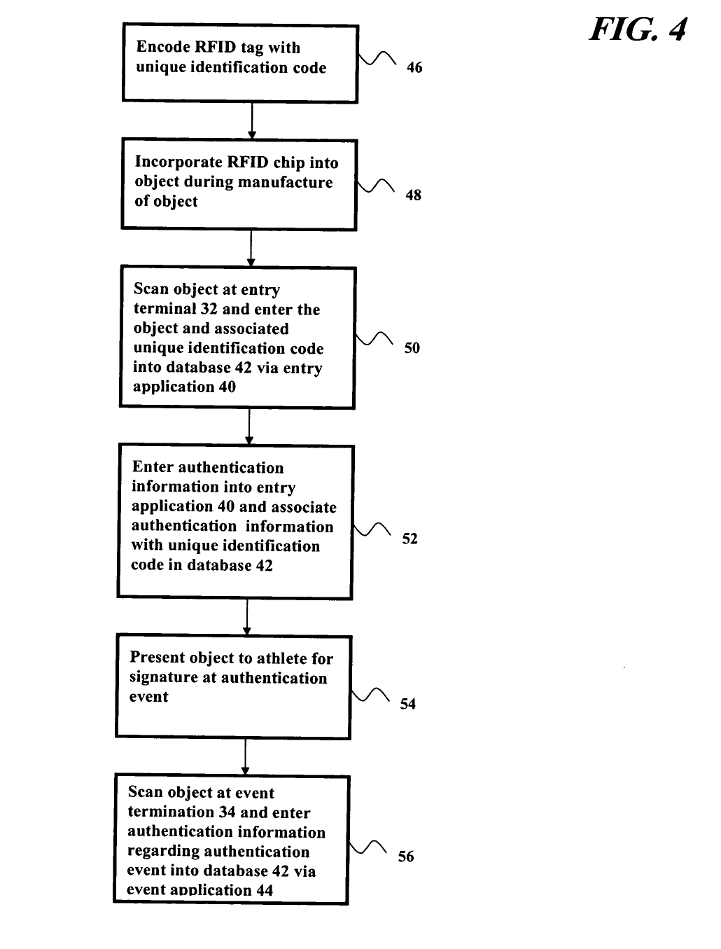

Referring to FIG. 3, there is shown a system of authenticating a signature on a sports memorabilia object in accordance with a preferred embodiment of the present invention. System 30 comprises a manufacturer entry terminal 32, multiple event terminals 34, and multiple authentication terminals in the form of kiosks 36. Each of these terminals 32, 34, and 36 are in communication with one or more servers 38 maintained by or on behalf of the manufacturer. The server includes a computerized entry application 40 programmed to facilitate initial entry of the sports object and the unique identification code for the sports object into a database 42. In addition, server 38 also includes a computerized event application 44 programmed to facilitate entry of authentication information regarding an authentication event into database 42 and associate such information with the applicable unique identification code for the object. Server 38 also contains a computerized authentication application 46 programmed to facilitate authentication of a sports object by a dealer or prospective purchaser. The manufacturer entry terminal 32, event terminals 34, and kiosks 36 each comprise an RF reader for use in scanning a sports object and transmitting the unique identification code to server 38. As previously discussed, the RF reader may be connected to a PC, laptop, or other terminal for purposes of transmitting the information to server 38, or alternatively may comprise a wireless device for such purposes.

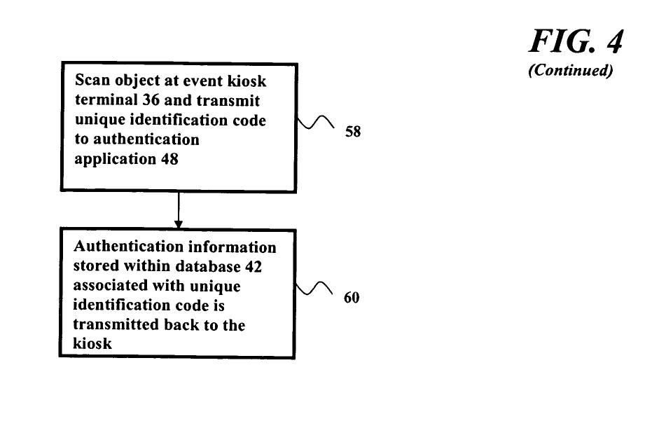

Looking to FIG. 4, there is shown in block diagram form a method of authenticating a signature on a sports memorabilia object utilizing the system illustrated in FIG. 3, including the steps taken to produce the sports object before it enters the marketplace and the steps taken to authenticate a signature when the object is subsequently sold to a dealer, collector, or other individual.

Looking to FIG. 4, in step 46, an RFID tag is encoded with a unique identification code, such as “RAW123456.” This identification code may comprise a serial number portion (e.g. “RAW123”) and a security code portion (e.g., “456”). The tag may be encoded by the manufacturer of the tag, by the manufacturer of the sports object, or by any other entity. As stated above, the tag is preferably read-only and non-reprogrammable so as to eliminate the possibility of tampering with the unique identification code by counterfeiters. The entirety of the identification code, or the security code portion, may be encrypted.

In step 48, the RFID tag is incorporated within the sports object during the manufacturing process. For baseball 10 illustrated in FIG. 2, indicator 28 is implanted within core 12 during molding of the core, although other locations are of course possible.

In step 50, the manufacturer of the sports objects scans each object produced with an RF reader at entry terminal 32 to enter the object and associated unique identification code into database 42 maintained by or on behalf of the manufacturer. In the preferred embodiment, the manufacturer utilizes entry application 40 for purposes of entering the unique identification code into the database. Entry application 40 and database 42 are stored on or connected to host computer or server 38 accessible via a network of dedicated communication links (an “Intranet system”) or via the Internet. Access to entry application 40 and database 42 may be controlled via password or other types of security protections. The RF reader may be connected for communicating with the server via a PC, laptop or other entry terminal 32.

Entry application 40 is programmed to interact with the entry operator via a user interface presented to the operator on the screen of a PC, laptop, or other screen at entry terminal 32. The entry operator will initiate the entry process selecting his or her intention to enter a new object into database 42. The entry operator will then be prompted to scan the object using the RF reader. Upon scanning the object, the RF reader automatically transmits the unique identification code to the entry application in electronic form. In this manner, the unique identification is not made known to the operator of the RF reader to further enhance the security of the system. Alternatively, a serial number portion of the identification code is made known to the operator, and a security code portion is transmitted to the database only.

In step 52, the entry operator may also be prompted to input authentication information into entry application 40 regarding the sports object. This authentication information may include the date and place of manufacture, a description of the object (e.g., “leather-covered baseball”), and a description of the authenticating event for which the object is intended, if known. Upon entry, the entry application will associate the authentication information with the unique identification code within database 42 for purposes of authenticating the object at a later date.

The sports object is later presented in step 54 at an authentication event, such as an autographing session with a sports personality or other notable individual. For example, baseball 10 in FIG. 1 has been signed by “John Doe” as evidenced by signature 26 on the exterior surface of outer cover 22. Preferably, the sports object is signed in the presence of one or more witnesses in order to provide additional information for authenticating signature 26.

In step 56, a representative or agent of the manufacturer attending the authentication event scans the object at event terminal 34 using the RF reader and enters authentication information regarding the authentication event for inclusion within database 42 to be associated with the object, such as the name of the sports personality who signed the object (e.g., “John Doe”), the date on which the object was signed, and the name of one or more witnesses who witnessed the signing of the object. In the preferred embodiment, this function is accomplished through the use of computerized event application 44 that prompts the representative to scan the object and enter the authentication information. The RF reader will preferably automatically transmit the unique identification to the event application electronically such that the unique identification code is not made known to the representative. Alternatively, a serial number portion of the identification code may be made known to the representative for inclusion on a certificate of authenticity. A security code portion of the identification code will not be displayed to the representative. The event application will associate the authentication information regarding the authentication event with the unique identification code in database 42. The representative may also attach additional documents or materials to be associated with the unique identification code in database 42, such as a photograph of the object, a photograph or video of the person signing the autograph, historical or background information about the object or the person signing the object.

If the person or entity who originally acquired the sports object (such as a dealer) subsequently decides to sell or otherwise transfer the object to another entity (such as a collector) at a sports show or similar event at which such items are traded, he/she will be able to authenticate the signature on the sports object.

In step 58, the object is scanned using an RF reader and the unique identification code associated with that object is obtained. The unique identification code is then transmitted for purposes of authenticating the object by comparison to database 42. In the preferred embodiment, authentication is accomplished by a computerized authentication program 46 stored on server 38 maintained by or on behalf of the manufacturer and having access to database 42. The RF reader directly transmits the unique identification code to the authentication application electronically such that it is not made known to the scanner or others. Alternatively, a serial number portion of the identification code will be displayed to the scanner which can be verified as against the certificate of authenticity. A security code portion of the identification code is not shown to the scanner. The authentication application 46 is programmed to receive and decode the transmission from the RF reader, and to determine the authenticity of the object by reference to database 42. In a preferred embodiment, the authenticity can be verified by a verification service at a kiosk or other authentication terminal 36 at a show. The kiosk 36 will be connected to an RF reader and will connect to the authentication application 46 via an Intranet system or the Internet to verify the authenticity of the object. Alternatively, the authenticity application may be accessible on the Internet, and the dealer or prospective buyer uses an RF reader or an NFC-enabled device such as a cell phone, PDA or other consumer wireless device to scan the object and transmit the data directly to the authenticity application.

In step 60, the authenticity application can then display and provide the authentication information associated with the unique identifier so transmitted, and can also display any additional documents or materials associated with the object upon request. If the unique identification code is not located in database 42, the authenticity application can convey that the object is not found indicating that the item is not authentic. In addition, if the authenticating information provided to the dealer or prospective purchaser does not “match” the object and information being provided by the seller, the dealer or prospective purchaser can deduce that the object is not genuine.

In addition to autograph sessions, it is anticipated that the object may be used in play and that, if the object is used in an important play, such as a record-breaking home run or a game winning touchdown, the object can be associated with that event for authentication purposes. This may be accomplished in baseball, for example, by having an event terminal 34 at the game whereby each ball is scanned prior to its use in the game. The authentication information initially entered may be the date and teams playing in the game, the inning, the batter and the number order of the ball for that hitter at bat (e.g. “3^{rd} ball”). Additional authentication information can be added about the play such as if a home run is hit.

It is to be understood that the preferred system and method illustrated in FIGS. 3 and 4 are merely exemplary of a system and method for authenticating a sports memorabilia object in accordance with the present invention, and that other variations are of course possible. For example, rather than transmit the identification code to a server, the entirety of the unique identification code may be displayed to the user upon scanning. The user can then connect with a master list or database maintained by the manufacturer and search for the unique identification code. If the user has access to the Internet, such as through a lap-top or PC, he/she can log-on to the Web site that contains the database and attempt to locate the unique identification code such as through a keyword search. If the user does not have access to the Internet, he/she can alternately call a toll-free telephone number and attempt to locate the unique identification code by speaking to a customer service representative, by entering and receiving information through a voice response system or telephone keypad commands, or by any other suitable means. If the user does not locate the unique identification code in the database, he/she will receive a response stating that the identification code is invalid, thereby indicating that the signature on the sports item is not authentic. If, however, the collector does locate the unique identification code in the database, he/she can review the authenticating information (if any) associated with the unique identification code to determine if such information corresponds with the sports object.

Although the preferred embodiment has been illustrated in detail hereinabove with respect to a baseball, it is to be understood that the indicator such as a transponder could also be implanted within a variety of other sports items. For example, the indicator could be inserted into the hollow portion of an aluminum or composite bat, or, a small cavity could be made inside a wood bat to allow for the insertion of a transponder. Also, the indicator could be inserted between the bladder and shell of a football, basketball, soccer ball, volleyball or any other type of inflatable device. The indicator could likewise be secured between the inner and outer panels of the back of a baseball glove. Thus, it can be seen that the present invention is applicable to a wide variety of sports memorabilia.

Finally, while the present invention has been described and illustrated hereinabove with regard to a preferred embodiment, it should be understood that many types of authentication indicators and corresponding detection devices could be utilized without departing from the scope of the present invention.

1. A sports memorabilia object to be authenticated, said object comprising:
an authentication indicator incorporated into the object during manufacture of the object such that the authentication indicator is not accessible from the exterior of the object without disassembly of the object, wherein said authentication indicator is adapted to be detected by a detection device to thereby authenticate the item.

2. The sports memorabilia object of claim 1, wherein said object is a manufactured sporting goods article.

3. The sports memorabilia object of claim 2, wherein said object is selected from the group consisting of a baseball, softball, ball bat, ball glove, helmet, football, basketball, soccer ball, volleyball, hockey stick, and lacrosse stick.

4. The sports memorabilia object of claim 1, wherein the object is associated with an authentication event that makes the object unique and collectable as memorabilia.

5. The sports memorabilia object of claim 4, wherein the object comprises an original signature or autograph of a well-known sports figure.

6. The sports memorabilia object of claim 1, wherein said authentication indicator is assigned a unique identifier uniquely associated with the specific object into which the indicator is incorporated, and said unique identifier is detectable by said detection device.

7. The sports memorabilia object of claim 6, wherein said authentication indicator comprises a device capable of communicating said unique identifier to said detection device.

8. The sports memorabilia object of claim 7, wherein said authentication indicator comprises a transponder programmed with said unique identifier.

9. The sports memorabilia object of claim 8, wherein said transponder is passive.

10. The sports memorabilia object of claim 9, wherein said transponder is read-only.

11. The sports memorabilia object of claim 10, wherein said transponder is programmed with said unique identifier before incorporation into said object.

12. A process for making a sports memorabilia object to be authenticated, said method comprising:
incorporating an authentication indicator into the object during manufacture of the object such that the authentication indicator is not accessible from the exterior of the object without disassembly of the object, wherein said authentication indicator is adapted to be detected by a detection device to thereby authenticate the item.

13. The process of claim 12, wherein said object is a manufactured sporting goods article.

14. The process of claim 13, wherein said object is selected from the group consisting of a baseball, softball, ball bat, ball glove, helmet, football, basketball, soccer ball, volleyball, hockey stick, and lacrosse stick.

15. The process of claim 12, wherein the object is associated with an authentication event that makes the object unique and collectable as memorabilia.

16. The process of claim 15, wherein the object comprises an original signature or autograph of a well-known sports figure.

17. The process of claim 12, wherein said authentication indicator is assigned a unique identifier uniquely associated with the specific object into which the indicator is incorporated, and said unique identifier is detectable by said detection device.

18. The process of claim 17, wherein said authentication indicator comprises a device capable of communicating said unique identifier to said detection device.

19. The process of claim 18, wherein said authentication indicator comprises a transponder programmed with said unique identifier.

20. The process of claim 19, wherein said transponder is passive.

21. The process of claim 20, wherein said transponder is read-only.

22. The process of claim 21, wherein said process comprises the additional step of first programming the transponder with said unique identifier before incorporation into said object.

23. The process of claim 17, wherein said process comprises the additional step of associating the unique identifier with authentication information specific to the object in which the indicator is incorporated.

24. The process of claim 23, wherein said associating step comprises entering the unique identifier and the authentication information into a computerized database.

25. The process of claim 17, wherein said unique identifier is provided in said authentication indicator in encrypted form.

26. The sports memorabilia object of claim 1, wherein said authentication indicator is an RFID tag implanted within said object during manufacture thereof.

27. The process of claim 12, wherein said authentication indicator is an RFID tag programmed with a unique identifier that can be detected by an RF reader.

28. A method for producing a sports memorabilia object, said method comprising:
incorporating a unique indicator within a sporting goods object during manufacture of the object such that the indicator is not visible on the exterior of the item;
presenting the object for an authenticating event; and
associating the unique indicator with authentication information regarding the object.

29. A method for authenticating a sports memorabilia object, said method comprising:
incorporating a unique indicator within a sporting goods object during manufacture of the object such that the indicator is not visible on the exterior of the item;
presenting the object for an authenticating event;
associating the unique indicator with authentication information regarding the object;
detecting the unique indicator associated with the object using a detection device; and
reviewing the authenticating information associated with the unique indicator to thereby determine if the object is genuine.
